(19) United States
(12) Patent Application Publication
(10) Pub. No.: US 2018/0271103 A1
(43) Pub. Date: Sep. 27, 2018

(54) INSECT PREVENTION METHOD OF PLANTS BY USING A PREPARED ORGANIC ACID SALT SOLUTION

(71) Applicant: NORD-ELLE INT. CO., LTD., Kaohsiung City (TW)

(72) Inventor: CHIN-LIN SHIH, KAOHSIUNG CITY (TW)

(21) Appl. No.: 15/465,790

(22) Filed: Mar. 22, 2017

(51) Int. Cl. A01N 59/16

(52) U.S. Cl. CPC A01N 59/16

(57) ABSTRACT

A prepared organic acid salt solution for insect prevention is disclosed. A diluted aqueous solution of an organic acid salt is prepared to have a certain concentration, and then mixed with diatomaceous earth in a specific weight ratio to obtain a protection solution containing a silicate. The protection solution is uniformly sprayed on the surfaces of plants for avoiding insects to protect plants.

### BACKGROUND

### Field of Invention

The disclosure relates to an insect prevention method of plants by using a prepared organic acid salt solution. More particularly, the disclosure relates to a diluted aqueous solution of an organic acid salt having a certain concentration and mixed with diatomaceous earth in a specific weight ratio to obtain a protection solution containing a silicate. The protection solution is uniformly sprayed on the surfaces of plants for avoiding insects to protect plants.

### Description of Related Art

The climate of Taiwan is hot and humid. In the cultivation process of plants, plant diseases and insect pests often occurs to affect the plant growth. Although chemicals can be used to prevent and suppress the occurrences of the plant diseases and insect pests in time, the chemicals can remain on the plants and cause water pollution. Therefore, problems of drug resistance and rampant again are often occurred. Hence, how to properly use the chemicals to reduce the drawbacks thereof is an important issue in developing agriculture.

Taiwan patent number I375517(B) disclosed a prevention and control method of mollusks. In TW I375517(B), special carbohydrate compounds are used to trap and kill the mollusks, such as snails and slugs. In Taiwan patent number I484911(B), castor oil and an induced substance were mixed to decrease the hydrolysis rate of the induced substance, so that the used dose of the induced substance can be reduced. However, the composition is only suitable for flies.

In Taiwan patent number I531555 (B), a natural farming method is disclosed. A certain nutrient and a prevention chemical solution was used to treat malnutrition and infected evergreen fruit trees. However, this method is more time consuming and complicated.

Furthermore, potassium silicate may also be diluted more than 1000 times before being sprayed on plant leaves to reduce the powdery mildew incidence rate of tomatoes, cucumbers, grapes, strawberries and wheat, as well as inhibit the growth of mold or fungus to improve the protection effect. The purpose of spraying potassium silicate aqueous solution is to prevent the plants from being infected by microorganisms. However, since the potassium silicate aqueous solution is alkaline and easily blocks the plant leaf stomata, and plant is thus withered.

### SUMMARY

In view of the shortcomings in the existing methods of controlling plant diseases and insect pests, the inventors develop this invention by the many-year manufacturing and design experience and knowledge in the related fields and ingenuity.

This disclosure is related to an inset prevention method of plants by using a prepared organic acid salt solution. The method comprises preparing a first solution by adding an organic acid salt into pure water in a weight ratio of 1:100 to 1:600; preparing a protection solution containing a silicate by adding a diatomaceous earth into the first solution in a weight ratio of 1:1 to 1:500; and uniformly spraying the protection solution on a surface of a plant to protect the plant from being infringed by an herbivorous insect.

In one embodiment of this invention, the organic acid salt is an amino acid salt, a fatty acid salt, an acetate, or a combination thereof.

In one embodiment of this invention, the amino acid salt is a salt of alanine, phenylalanine, cysteine, cystine, aspartic acid, asparagine, glutamic acid, glutamine, glycine, histidine, leucine, isoleucine, lysine, methionine, proline, arginine, serine, threonine, valine, tryptophan, tyrosine, selenocysteine, pyrrolysine, and a composite amino acid thereof. The fatty acid salt is a composite fatty acid salt prepared from a plant oil or an animal fat.

In one embodiment of this invention, the plant oil is at least one of soybean oil, rape seed oil, olive oil, castor oil, sunflower oil, coconut oil, corn oil, cottonseed oil, linseed oil, palm oil, peanut oil, sesame oil, safflower oil, tung oil, canola oil, sweet almond oil, hazelnut oil, pistachio oil, and bayberry oil. The animal fat is at least one of lard, beef tallow, fish oil, chicken fat, goose fat, and horse fat.

In one embodiment of this invention, the organic acid salt is a potassium salt, a sodium salt, a calcium salt, a magnesium salt, an ammonium salt, or a combination thereof.

In one embodiment of this invention, the weight ratio of the organic acid salt to the pure water is 1:100 to 1:400.

In one embodiment of this invention, the protection solution is an insect repellent, a contact insecticide, or a combination thereof.

In one embodiment of this invention, the insect is Aphidoidea, Coccoidea, Spodoptera litura, Tetranychus urticae, or a combination thereof.

In one embodiment of this invention, the prevention and cure rate of aphids is at least 60%.

In one embodiment of this invention, the plant is flower cucumber, sweet potato, papaya, or a combination thereof.

Accordingly, an organic acid salt solution is prepared for insect prevention. This organic acid salt solution is prepared by using a simple and nontoxic composition with the diatomaceous earth to obtain the protection solution containing silicates. Without causing an environmental burden, the protection solution can prevent and cure the hurts caused by many kinds of herbivorous insects, especially Aphidoidea, Coccoidea, Spodoptera litura, and Tetranychus urticae.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 are photos under microscopes showing Aphis gossypii after being sprayed by protection solution of this invention.

FIG. 2 is a diagram showing the prevention and cure rate of Aphis gossypii.

FIG. 3 are photos under a microscope showing Tetranychus urticae after being sprayed by the protection solution of this invention.

FIG. 4 is a diagram showing the prevention and cure rate of Tetranychus urticae.

FIG. 5 is a photo showing the artificial breeding of Spodoptera litura for experimenting.

FIG. 6 is a photo showing the artificial-bred Spodoptera litura after being sprayed by the protection solution of this invention.

FIG. 7 is a diagram showing the prevention and cure rate of Spodoptera litura.

FIG. 8 are photos under a microscope showing Brevennia rehi after being sprayed by the protection solution of this invention.

FIG. 9 is a photo showing the dead Brevennia rehi after being sprayed by the protection solution of this invention.

FIG. 10 is a diagram showing the prevention and cure rate of Brevennia rehi.

### DETAILED DESCRIPTION

According to the aspects and the functions of this invention, the advantages will be illustrated in conjunction with the specific embodiments in light of the results shown in the following figures, so that the examiner can have a deeper and more specific understanding of the present invention.

This disclosure is related to an inset prevention method of plants by using a prepared organic acid salt solution. The method comprises the following steps. A first solution is prepared by adding an organic acid salt into pure water in a weight ratio of 1:100 to 1:600. A protection solution containing a silicate is prepared by adding a diatomaceous earth into the first solution in a weight ratio of 1:1 to 1:500 according to a chemical reaction equation (1) or (2) below

2RCOOB+H₂O+SiO₂⇄B₂SiO₃+2RCOOH (1)

(RCOO)₂B+H₂O+SiO₂⇄BSiO₃+2RCOOH (2)

In the chemical reaction equation (1) and (2) above, R is an organic group, B is a cation. The protection solution is uniformly sprayed on surfaces of plants to protect the plants from being infringed by herbivorous insects.

The organic acid salt may be an amino acid salt, a fatty acid salt, an acetate, or a combination thereof. The amino acid salt above may be a salt of alanine, phenylalanine, cysteine, cystine, aspartic acid, asparagine, glutamic acid, glutamine, glycine, histidine, leucine, isoleucine, lysine, methionine, proline, arginine, serine, threonine, valine, tryptophan, tyrosine, selenocysteine, pyrrolysine, and a composite amino acid thereof. The fatty acid salt above may be a composite fatty acid salt prepared from a plant oil or an animal fat. The plant oil may be at least one of soybean oil, rape seed oil, olive oil, castor oil, sunflower oil, coconut oil, corn oil, cottonseed oil, linseed oil, palm oil, peanut oil, sesame oil, safflower oil, tung oil, canola oil, sweet almond oil, hazelnut oil, pistachio oil, and bayberry oil. The animal fat may be at least one of lard, beef tallow, fish oil, chicken fat, goose fat, and horse fat. The amino acid salts, the fatty acid salts, or the acetates may be a potassium salt, a sodium salt, a calcium salt, a magnesium salt, an ammonium salt, or a combination thereof, and an addition amount thereof may be 1:100 to 1:400. Moreover, the protection solution may be an insect repellent, a contact insecticide, or a combination thereof, and can effectively prevent and cure the hurts made by Aphidoidea, Coccoidea, Spodoptera litura, Tetranychus urticae, or a combination thereof.

Accordingly, the embodiments below can further prove the practically applicable scope of this invention, but it is not intended to limit the scope of this invention thereto.

### I. Preparation of Organic Acid Salt

(1) Potassium fatty acid complex derived from soybean oil

18.9 g of potassium hydroxide (KOH) was dissolved in 42 g of water to obtain a KOH solution. 100 g of soybean oil was mixed with the KOH solution and blended thoroughly to obtain a mixture. The mixture was stand at least for 2 weeks to obtain a potassium fatty acid complex derived from soybean oil.

(2) Sodium fatty acid complex derived from corn oil

13.6 g of sodium hydroxide (NaOH) was dissolved in 33 g of water to obtain a NaOH solution. 100 g of corn oil was mixed with the NaOH solution and blended thoroughly to obtain a mixture. The mixture was stand at least for 4 weeks to obtain a sodium fatty acid complex derived from corn oil.

II. Protection Test of Aphis gossypii

Protection solutions used in this test were prepared as below: (1) 1 g of potassium fatty acid complex derived from soybean oil was dissolved in 100 g of water, and then added 0.2 g of diatomaceous earth to obtain a first protection solution (1 wt % potassium fatty acid complex derived from soybean oil and 0.2 wt % diatomaceous earth); (2) 1 g of potassium fatty acid complex derived from soybean oil was dissolved in 200 g of water, and then added 0.4 g of diatomaceous earth to obtain a second protection solution (0.5 wt % potassium fatty acid complex derived from soybean oil and 0.2 wt % diatomaceous earth); (3) 1 g of potassium fatty acid complex derived from soybean oil was dissolved in 400 g of water, and then add 0.8 g of diatomaceous earth to obtain a third protection solution (0.25 wt % potassium fatty acid complex derived from soybean oil and 0.2 wt % diatomaceous earth).

The leaves of Cucumis sativus L. and the Aphis gossypii on the leaves were collected. The leaves were tailored into a size of 5 cm×5 cm, and then put in petri dishes having a diameter of 9 cm in a manner of leaves back up. About 30 Aphis gossypii were in each petri dish. The first, second, and third protection solutions, as well as an aqueous solution containing 0.2 wt % diatomaceous earth (to be a control group) were respectively sprayed on the leaves by a pressurized sprayer. After 24 hours (i.e. the first day), the death of Aphis gossypii was observed. Next, the protection solutions and the aqueous solution of diatomaceous earth were sprayed again. After 24 hours (i.e. the second day) and 72 hours (i.e. the fourth day), the death of Aphis gossypii was observed again, and the prevention and cure rates were calculated. Each treatment was repeated for 4 times. The prevention and cure rate of Aphis gossypii was calculated according to the formula below:

prevention and cure rate (%)=(death rate of experimental group−death rate of control group)/(1−death rate of control group)×100%.

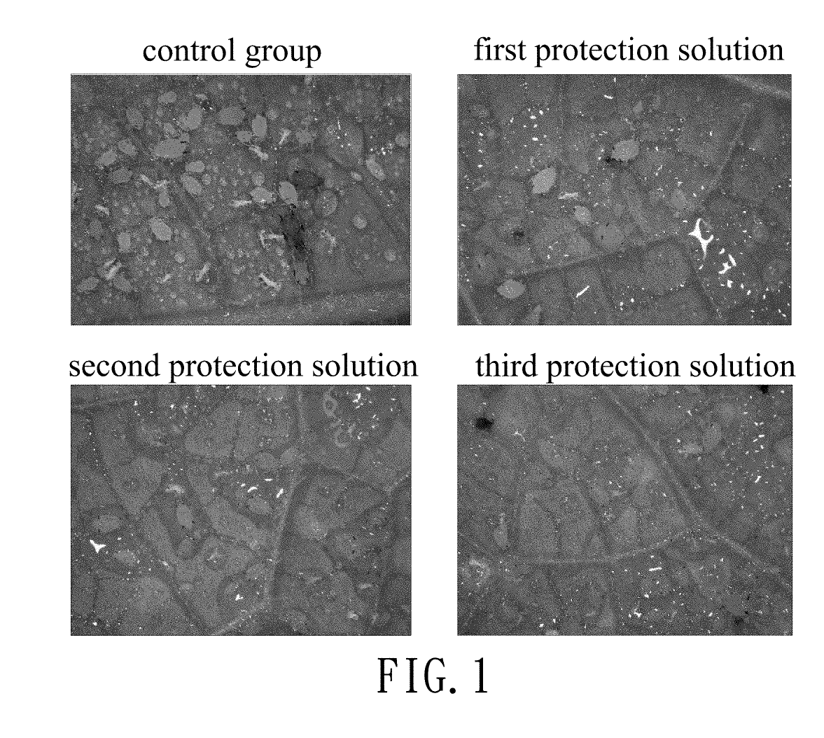

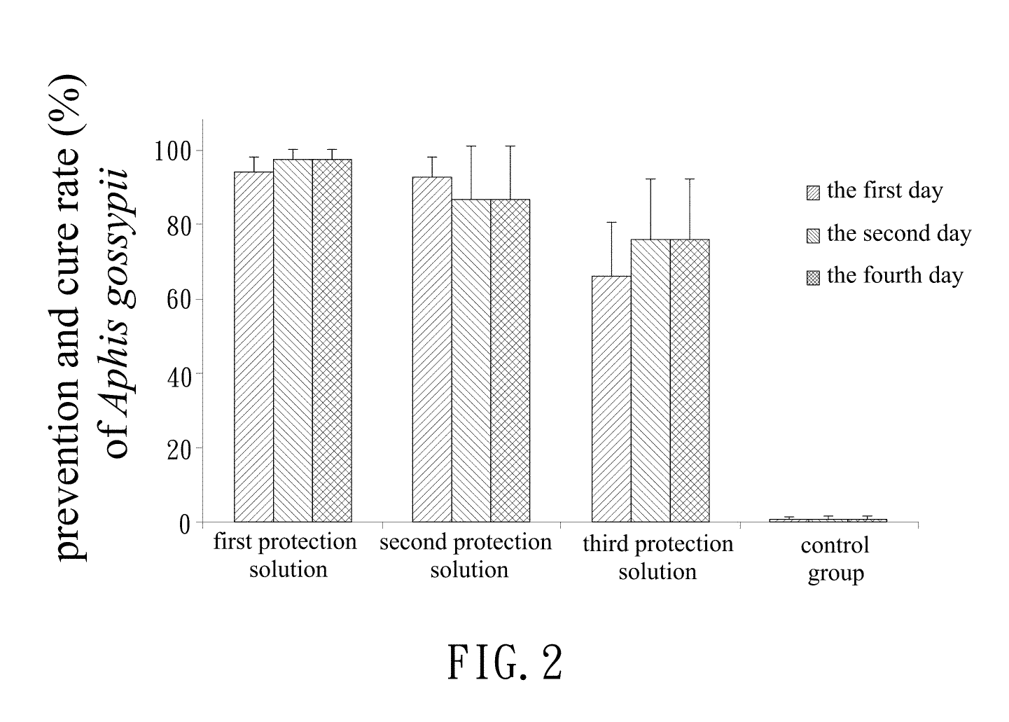

Please refer to FIG. 1. When the protection solutions were just sprayed, the Aphis gossypii were apparently covered by the protection solutions, under a microscope. Please refer to FIG. 2. The prevention and cure rate of the first protection solution in the first day (24 hours after the first spray) was 94.3%, and both in the second and the fourth day (after the second spray) were 97.6%. The prevention and cure rate of the second protection solution in the first day (24 hours after the first spray) was 92.9%, and both in the second and the fourth day (after the second spray) were 87.3%. The prevention and cure rate of the third protection solution in the first day (24 hours after the first spray) was 66.3%, and both in the second and the fourth day (after the second spray) were 76.2%. In general, the three kinds of protection solutions containing silicates obtained from the organic acid salt in different concentrations had a prevention and cure rate above 65%.

III. Protection Test of Tetranychus urticae

Protection solutions used in this test were prepared as below: (1) 1 g of potassium fatty acid complex derived from soybean oil was dissolved in 100 g of water, and then added 0.2 g of diatomaceous earth to obtain a first protection solution (1 wt % potassium fatty acid complex derived from soybean oil and 0.2 wt % diatomaceous earth); (2) 1 g of potassium fatty acid complex derived from soybean oil was dissolved in 200 g of water, and then added 0.4 g of diatomaceous earth to obtain a second protection solution (0.5 wt % potassium fatty acid complex derived from soybean oil and 0.2 wt % diatomaceous earth); (3) 1 g of potassium fatty acid complex derived from soybean oil was dissolved in 400 g of water, and then add 0.8 g of diatomaceous earth to obtain a third protection solution (0.25 wt % potassium fatty acid complex derived from soybean oil and 0.2 wt % diatomaceous earth).

The leaves of Carica papaya and the Tetranychus urticae on the leaves were collected. The leaves were tailored into a size of 5 cm×5 cm, and then put in petri dishes having a diameter of 9 cm in a manner of leaves back up. About 30 Tetranychus urticae were in each petri dish. The first, second, and third protection solutions, as well as an aqueous solution containing 0.2 wt % diatomaceous earth (to be a control group) were respectively sprayed on the leaves by a pressurized sprayer. After 24 hours (i.e. the first day), the death of Tetranychus urticae was observed. Next, the protection solutions and the aqueous solution of diatomaceous earth were sprayed again. After 24 hours (i.e. the second day) and 72 hours (i.e. the fourth day), the death of Tetranychus urticae was observed again, and the prevention and cure rates were calculated. Each treatment was repeated for 4 times. The prevention and cure rate of Tetranychus urticae was calculated according to the formula below:

prevention and cure rate (%)=(death rate of experimental group−death rate of control group)/(1−death rate of control group)×100%.

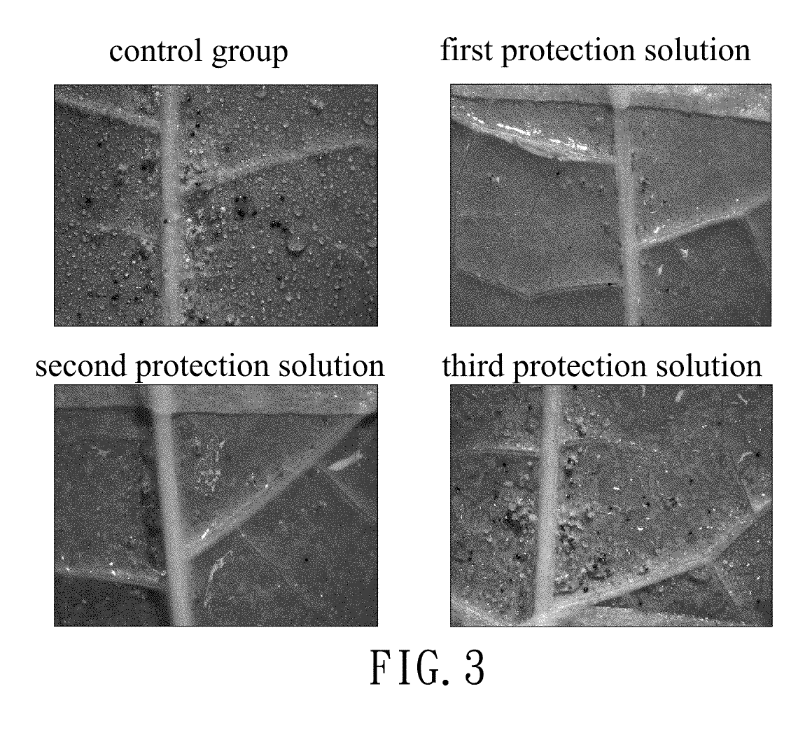

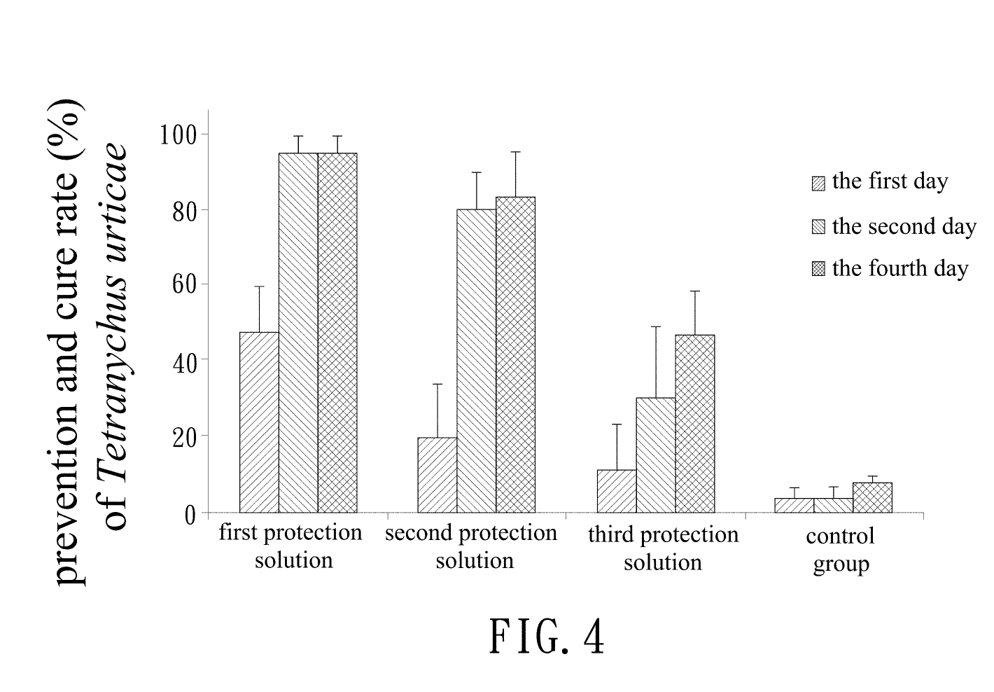

Please refer to FIG. 3. After the protection solutions were sprayed, Tetranychus urticae were also covered by the protection solutions. However, after the protection solutions were dried, most of the Tetranychus urticae will start to move without being affected too much. Please also refer to FIG. 4. In the first day (24 hours after the first spray), the first protection solution had the highest prevention and cure rate, which was 63.3%, and the prevention and the cure rates of the second and the third protection solutions were 36.7% and 13.3%, respectively. The second spray of the protection solutions could effectively increase the prevention and cure rate in the first day. In both of the second and the fourth days (after the second spray), the prevention and cure rates of the first protection solution and the second protection solution were 93.3% and 80%, respectively. However, the prevention and cure rates of Tetranychus urticae by using the third protection solution are not good enough. Until the test was finished (i.e. the fourth day), the prevention and cure rate was only 46.7%.

IV. Protection Test of Spodoptera litura

Protection solutions used in this test were prepared as below: (1) 1 g of sodium fatty acid complex derived from corn oil was dissolved in 100 g of water, and then added 0.2 g of diatomaceous earth to obtain a first protection solution (1 wt % sodium fatty acid complex derived from corn oil and 0.2 wt % diatomaceous earth); (2) 1 g of sodium fatty acid complex derived from corn oil was dissolved in 200 g of water, and then added 0.4 g of diatomaceous earth to obtain a second protection solution (0.5 wt % sodium fatty acid complex derived from corn oil and 0.2 wt % diatomaceous earth); (3) 1 g of sodium fatty acid complex derived from corn oil was dissolved in 400 g of water, and then add 0.8 g of diatomaceous earth to obtain a third protection solution (0.25 wt % sodium fatty acid complex derived from corn oil and 0.2 wt % diatomaceous earth).

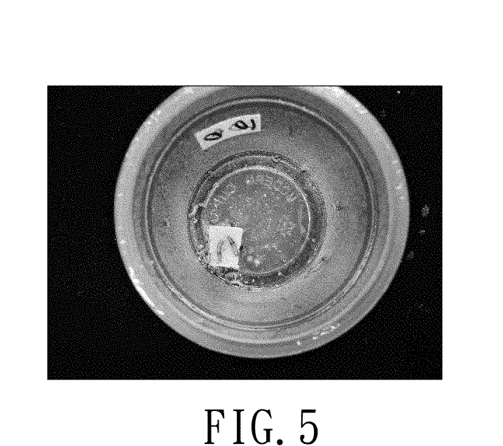

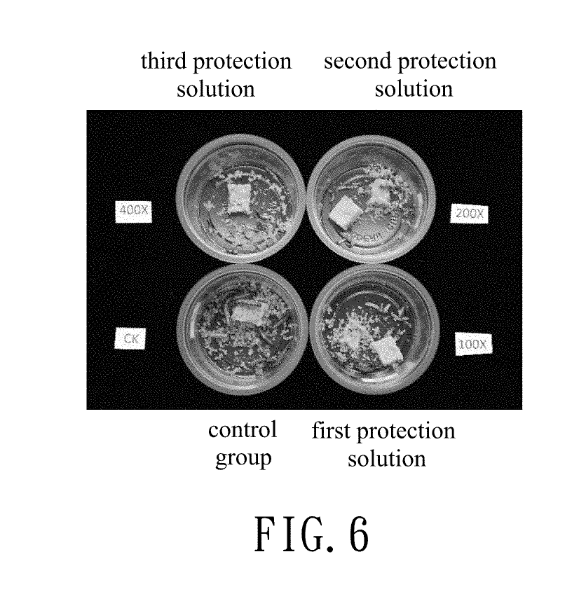

Please refer to FIG. 5. Artificial fed Spodoptera litura were placed in 150 mL plastic boxes. There were 20 larvae of Spodoptera litura at ages of about 3-4 in each of the plastic boxes for testing. Please refer to FIG. 6. The first, second, and third protection solutions, as well as an aqueous solution containing 0.2 wt % diatomaceous earth (to be a control group) were respectively sprayed the larvae. Afterwards, artificial feed was continuously provided as the food source. After 24 hours (i.e. the first day), the larvae death of Spodoptera litura was observed. Next, the protection solutions and the aqueous solution of diatomaceous earth were sprayed again. After 24 hours (i.e. the second day) and 72 hours (i.e. the fourth day), the larvae death of Spodoptera litura was observed again, and the prevention and cure rates were calculated. Each treatment was repeated for 4 times. The prevention and cure rate of Spodoptera litura was calculated according to the formula below:

prevention and cure rate (%)=(death rate of experimental group−death rate of control group)/(1−death rate of control group)×100%.

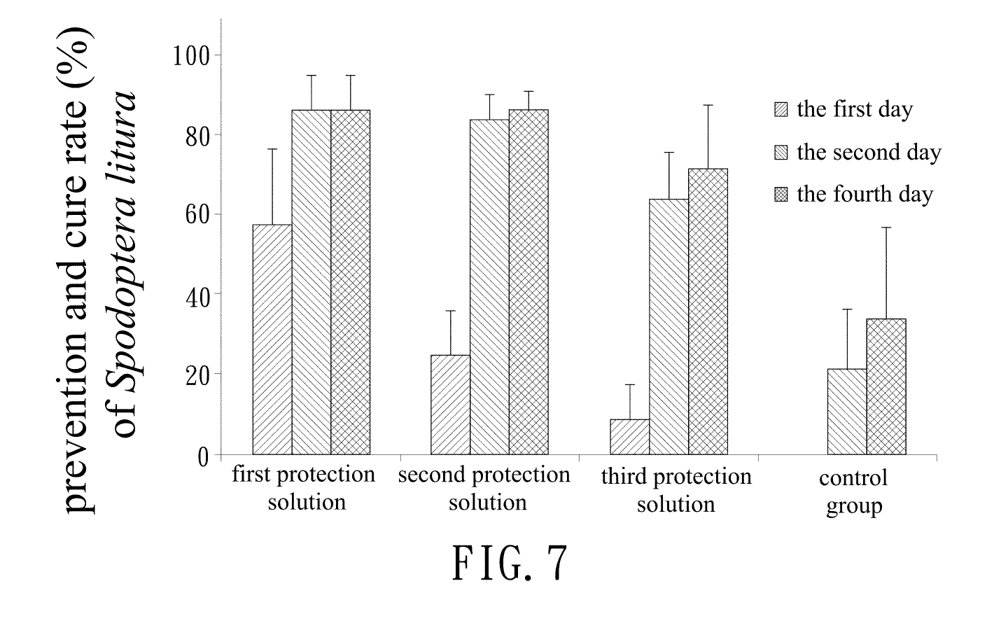

Please refer to FIG. 7, which is a diagram showing the prevention and cure rate of Spodoptera litura. 24 hours after the first spray (i.e. the first day), the prevention and cure rates all were not high. The prevention and cure rate of the first protection solution was 57.5%, and the prevention and cure rate of the third protection solution was only 8.8%. However, after second spray of the protection solutions, the prevention and cure rates of the three protection solutions were all increased. The prevention and cure rates of the first, second and third protection solutions were 86.3%, 83.8%, and 63.8%, respectively. As for the control group sprayed by the aqueous solution containing 0.2 wt % diatomaceous earth, the larvae death rate of the Spodoptera litura in the second day was apparently increased to more than 21.3%. Therefore, it was inferred that the Spodoptera litura will be affected by the aqueous solution containing 0.2 wt % diatomaceous earth to die.

V. Protection Test of Brevennia rehi

Protection solutions used in this test were prepared as below: (1) 1 g of sodium fatty acid complex derived from corn oil was dissolved in 100 g of water, and then added 0.2 g of diatomaceous earth to obtain a first protection solution (1 wt % sodium fatty acid complex derived from corn oil and 0.2 wt % diatomaceous earth); (2) 1 g of sodium fatty acid complex derived from corn oil was dissolved in 200 g of water, and then added 0.4 g of diatomaceous earth to obtain a second protection solution (0.5 wt % sodium fatty acid complex derived from corn oil and 0.2 wt % diatomaceous earth); (3) 1 g of sodium fatty acid complex derived from corn oil was dissolved in 400 g of water, and then add 0.8 g of diatomaceous earth to obtain a third protection solution (0.25 wt % sodium fatty acid complex derived from corn oil and 0.2 wt % diatomaceous earth).

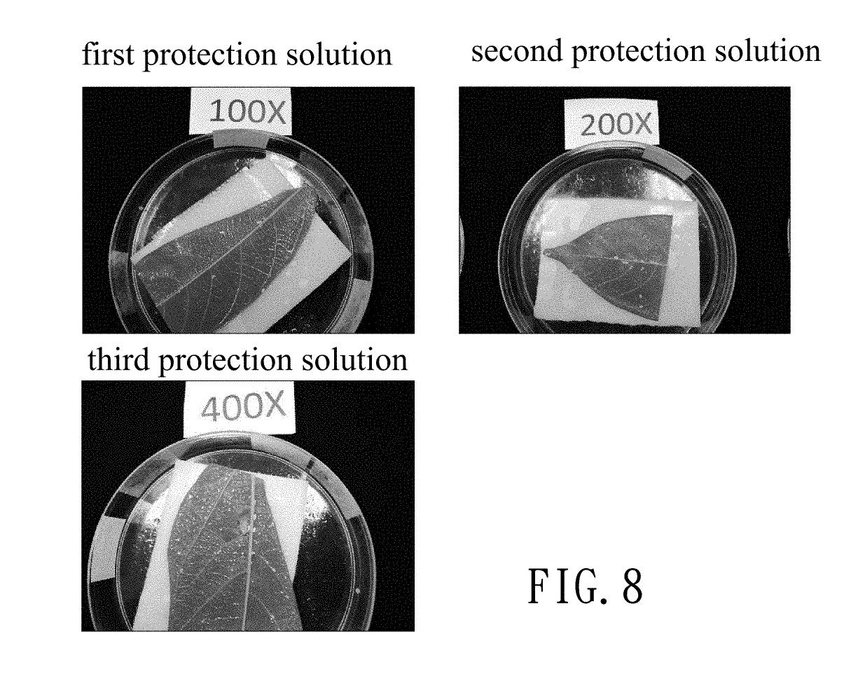

As shown in FIG. 8, the leaves of Manihot esculenta and the Brevennia rehi on the leaves were collected. The leaves were tailored into a size of 5 cm×5 cm, and then put in petri dishes having a diameter of 9 cm in a manner of leaves back up. 20 Brevennia rehi were in each petri dish. The main test objects were Brevennia rehi which had not spawn yet. The first, second, and third protection solutions, as well as an aqueous solution containing 0.2 wt % diatomaceous earth (to be a control group) were respectively sprayed on the leaves by a pressurized sprayer. After 24 hours (i.e. the first day), the death of Brevennia rehi was observed. Next, the protection solutions and the aqueous solution of diatomaceous earth were sprayed again. After 24 hours (i.e. the second day) and 72 hours (i.e. the fourth day), the death of Brevennia rehi was observed again, and the prevention and cure rates were calculated. Each treatment was repeated for 4 times. The prevention and cure rate of Brevennia rehi was calculated according to the formula below:

prevention and cure rate (%)=(death rate of experimental group−death rate of control group)/(1−death rate of control group)×100%.

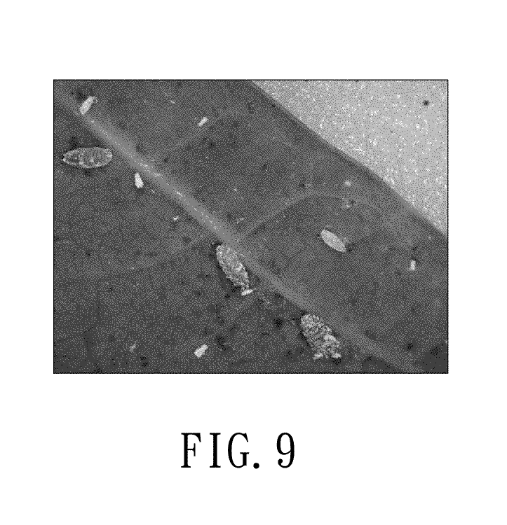

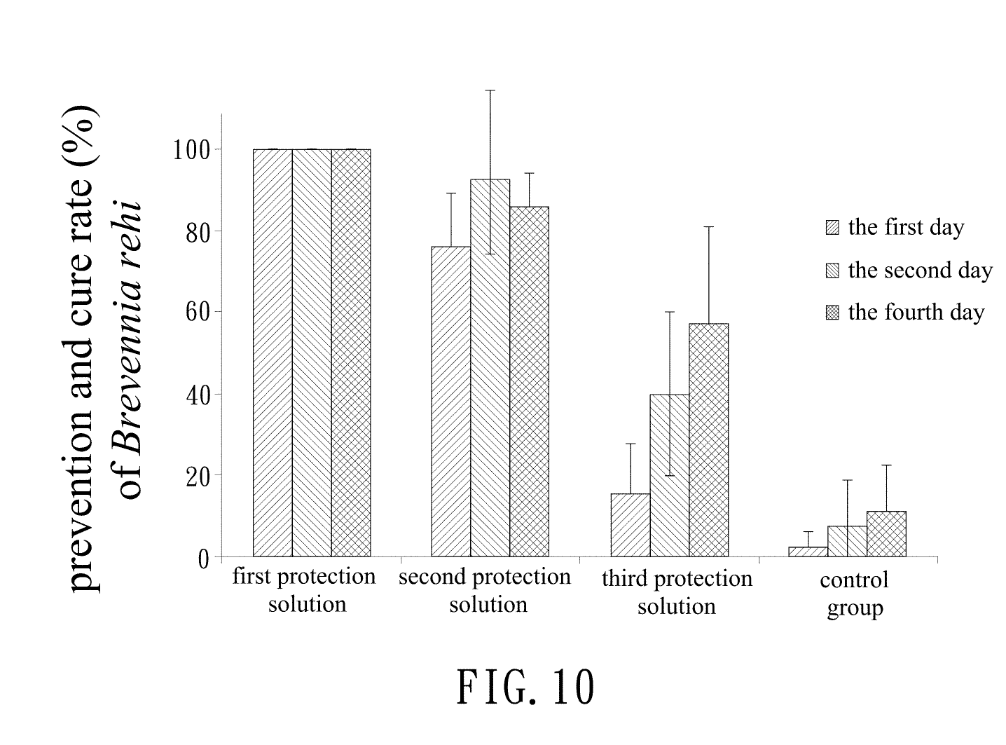

Please refer to FIG. 9. After the protection solutions were is sprayed, most of the Brevennia rehi were cover by the protection solutions and the wax powder thereof was obviously disappeared. If the Brevennia rehi is dead, no wax powder was secreted from the body surface. Some dead Brevennia rehi was observed to have tan to brown colors. Please refer to FIG. 10. The prevention and cure rate of the first protection solution could reach 100%.

The prevention and cure rate of the second protection was 76.1% on the first day, but the prevention and cure rate of the third protection solution was only 15.3% on the first day. In general, the prevention and cure rate of the second protection solution could be above 85% on the second and the fourth days, but the best prevention and cure rate of the third protection solution was only 57.1% on the fourth day.

From the illustrations of the embodiments above, it can be known that this invention, comparing with conventional technologies, has the following advantages:

1. In this invention, the protection solutions contain an organic acid salt and diatomaceous earth. The compositions of the protection solutions are simple, and the preparations and uses of the protection solutions are also simple. The soluble silicon from the diatomaceous earth can deposit on the surface of the plants to physically enhance the plant tissues, especially the toughness of the plant leaves. Therefore, it was difficult for the herbivorous insects to eat the plants, and the plants are finally repellent to the herbivorous insects and even can kill the insects after contacting the insects. Moreover, the protection solutions can form a transparent protection film on the leaves, so that the leaves are looked greener and more beautiful to solve the problem of leaving white traces on plants by the aqueous solution containing diatomaceous earth.

2. In this invention, a transparent and protective silicate film will be slowly formed on plant leaves after spraying the protection solutions on plant leaves. Comparing with the spraying potassium silicate aqueous solution directly on the leaves, the protection solutions of this invention can avoid blocking the plant leave stomata, so that the plant won't be withered.

3. In this invention, the insect prevention method of plants by using a prepared organic acid salt solution can prevent and cure plant hurts caused by many herbivorous insects, and the application range thereof is wide. In addition, the silicates and the salts can be absorbed by the plant leaves to be the nutrients for the plant growth.

In summary, the insect prevention method of plants by using a prepared organic acid salt solution can achieve the desired effect in light of the above disclosed embodiments. Moreover, this disclosure was not disclosed before the filing day. Therefore, this disclosure has fully compelled with the provisions and requirements of the patent law. This disclosure is applied for the utility patent according to the patent law. Please examine this disclosure and grant a patent.

However, the disclosure above was only used as embodiments, but used to limit the protection scope of this invention. Persons skilled in the art can make equivalent changes or modifications without departure from the scope of this invention.

What is claimed is:

1. An insect prevention method of plants by using a prepared organic acid salt solution, comprising:
preparing a first solution by adding an organic acid salt into pure water in a weight ratio of 1:100 to 1:600;
preparing a protection solution containing a silicate by adding a diatomaceous earth into the first solution in a weight ratio of 1:1 to 1:500; and
uniformly spraying the protection solution on a surface of a plant to protect the plant from being infringed by an herbivorous insect;
wherein chemical reaction equation of the protection solution containing a silicate is 2RCOOB+H₂O+SiO₂⇄B₂SiO₃+2RCOOH or (RCOO)₂B+H₂O+SiO₂⇄BSiO₃+2RCOOH, wherein R is an organic group and B is a cation.

2. The insect prevention method of claim 1, wherein the organic acid salt is an amino acid salt, a fatty acid salt, an acetate, or a combination thereof.

3. The insect prevention method of claim 2, wherein the amino acid salt is a salt of alanine, phenylalanine, cysteine, cystine, aspartic acid, asparagine, glutamic acid, glutamine, glycine, histidine, leucine, isoleucine, lysine, methionine, proline, arginine, serine, threonine, valine, tryptophan, tyrosine, selenocysteine, pyrrolysine, and a composite amino acid thereof.

4. The insect prevention method of claim 3, wherein the organic acid salt is a potassium salt, a sodium salt, a calcium salt, a magnesium salt, an ammonium salt, or a combination thereof.

5. The insect prevention method of claim 2, wherein the fatty acid salt is a composite fatty acid salt prepared from a plant oil or an animal fat.

6. The insect prevention method of claim 5, wherein the plant oil is at least one of soybean oil, rape seed oil, olive oil, castor oil, sunflower oil, coconut oil, corn oil, cottonseed oil, linseed oil, palm oil, peanut oil, sesame oil, safflower oil, tung oil, canola oil, sweet almond oil, hazelnut oil, pistachio oil, and bayberry oil, as well as the animal fat is at least one of lard, beef tallow, fish oil, chicken fat, goose fat, and horse fat.

7. The insect prevention method of claim 6, wherein the organic acid salt is a potassium salt, a sodium salt, a calcium salt, a magnesium salt, an ammonium salt, or a combination thereof.

8. The insect prevention method of claim 1, wherein the organic acid salt is a potassium salt, a sodium salt, a calcium salt, a magnesium salt, an ammonium salt, or a combination thereof.

9. The insect prevention method of claim 1, wherein the weight ratio of the organic acid salt to the pure water is 1:100 to 1:400.

10. The insect prevention method of claim 1, wherein the protection solution is an insect repellent, a contact insecticide, or a combination thereof.

11. The insect prevention method of claim 1, wherein the insect is Aphidoidea, Coccoidea, Spodoptera litura, Tetranychus urticae, or a combination thereof.

12. The insect prevention method of claim 11, wherein a prevention and cure rate of Aphidoidea is at least 60%.

13. The insect prevention method of claim 1, wherein the plant is is flower cucumber, sweet potato, papaya, or a combination thereof.
